(19) United States
(12) Patent Application Publication
(10) Pub. No.: US 2006/0244352 A1
(43) Pub. Date: Nov. 2, 2006

(54) Diamond electron emitter and electron beam source using same

(75) Inventors: Natsuo Tatsumi, Itami-shi (JP); Yoshiki Nishibayashi, Itami-shi (JP); Takahiro Imai, Itami-shi (JP)

Correspondence Address: DARBY & DARBY P.C., P. O. BOX 5257, NEW YORK, NY, 10150-5257, US

(73) Assignee: Sumitomo Electric Industries, Ltd., Osaka-shi (JP)

(21) Appl. No.: 10/554,188

(22) PCT Filed: Sep. 15, 2004
(86) PCT No.: PCT/JP04/13873

§ 371 Date: Oct. 21, 2005

(30) Foreign Application Priority Data
Sep. 16, 2003 (JP) 2003322395

(51) Int. Cl. H01J 1/00

(52) U.S. Cl. 313/311

(57) ABSTRACT

An electron emission device which is smaller, able to operate at lower voltage and more efficient than the conventional device is provided. The device contains a light emitting device to irradiate light to a cathode wherein at least an electron emission face of the cathode is made of diamond. By composing the device in such a way, the voltage to draw out electrons can be lowered with a wide margin compared to the conventional device, and thus a small device which can be operated with low voltage may be obtained. The light emitting device can be formed as one unit with the cathode and it can also be that the light emitting device and the electrode are made of diamond. Furthermore, the electron emission face of the cathode is preferably an n- or p-type diamond semiconductor.

### TECHNICAL FIELD

The present invention relates to a diamond electron emission device, which is widely used in apparatuses for high frequency amplification, microwave oscillation, light emitting devices, electron beam lithography apparatus and the like, and an electron beam source using the diamond electron emission device.

### BACKGROUND ART

Recently, in addition to hot cathodes, cold cathode devices using molybdenum or carbon nano-tube and the like have been developed for electron emission devices. Also diamond cathodes are getting attention due to their negative electron-affinity.

Various forms have been proposed for the diamond cold cathode. For example, there are a pn junction type described in the publication WO93/15522, and a metal cathode coated with diamond described in Journal of Vacuum Science and Technology B14 (1996) 2050. In the pn junction type, as shown in FIG. 8, an n-type diamond 81 is layered on a p-type diamond 82, and an electrode 80 is disposed on the n-type diamond 81, wherein bias voltage is applied to the electrode to emit electrons. Further, a diamond cathode formed in an Si mold and sharpened is proposed in Japanese Laid Open Patent Publication No. Hei 8-264111 and the publication WO98/44529.

The diamond cathode described above pulls out electrons into a vacuum with a strong electric field. However, it is also possible to emit electrons from a cathode by light excitation of electrons. For example, there are proposals for this idea in Japanese Laid Open Patent Publication No. Hei 10-149761, Japanese Laid Open Patent Publication No. Hei 11-166860, Japanese Laid Open Patent Publication No. 2000-357449 and the like. These may be used for photodetectors by measuring emitted electrons.

### DISCLOSURE OF INVENTION

The devices disclosed in the patent publications described above can not pull out electrons from the devices into a vacuum unless a strong electric field or high operational voltage is applied. In the Spindt type cold cathode, which is attracting attention as a promising cold cathode, the operational voltage is lowered by disposing electrodes on many sharpened emitters, but even lower voltage operation is demanded to improve the operational efficiency and to reduce the driving power consumption.

The object of the present invention is to solve these problems and to provide an electron emission device which is smaller, operated at lower voltage and highly efficient, and an electron beam source using this electron emission device.

The diamond electron emission device in the present invention has a light emitting device to illuminate light to a cathode, and at least one electron emission face of the cathode is made of diamond. Since this device has a light emitting device, electrons can be excited by light to a higher level than a conduction band 21 of the diamond which is higher than the vacuum level 25 as shown in FIG. 4. Therefore the voltage required to draw out electrons can be reduced greatly and thus a small electron emitting device, which may be operated at low voltage, can be obtained.

The light emitting device is preferably made of diamond. Since the band gap is large in diamond, electrons may be excited with high energy, and thus the operation efficiency can be increased.

The electron emission face of the cathode is preferably an n-type semiconductor. Since the impurity level of n-type diamond is close to the conduction band, even if excited with low energy light, electrons are excited to the conduction band and electron emission occurs, resulting in higher efficiency.

The electron emission face of the cathode may be a p-type diamond semiconductor. Even if the band is bent on the surface of diamond, the potential is lowered near the surface and electrons excited to the conduction band are easily emitted. Furthermore, it is preferable that the p-type diamond semiconductor contains a crystal defect or sp2 component. The crystal defect includes empty lattice defect, defect due to impurity/empty lattice pairs, dislocation defect, grain boundary, twin crystal and the like. The sp2 component is graphite, noncrystalline carbon, fullerene and the like.

The diamond light emitting device emits not only high energy light such as free exciton luminescence but also low energy light such as band A. If there is a crystal defect, or a sp2 component is present, the energy level is increased in the band gap of diamond and the light of less energy is also utilized for electron excitation. Consequently the amount of electron emission may be increased.

The electron emission face of the cathode is preferably hydrogen terminated. When hydrogen terminated, the electron affinity of the surface of the diamond, which is an electron emission face, becomes negative and electrons excited by the conduction band are easily released to a vacuum.

Further, the electron emission face of the cathode may be oxygen terminated. In particular, when the electron emission face is n-type semiconductor and hydrogen terminated, positive holes generated on the surface reduce electrons which are carriers of the cathode, and the cathode resistance becomes high. However, if the surface is oxygen terminated, this phenomenon does not appear and the cathode resistance becomes low.

Still further, the light emitting device is preferably pn junction of diamond. Since the light emitting device made of the pn junction diamond emits short wavelength light such as free exciton emission at 5.27 eV, the electron emission is facilitated. Also, using the same material as the cathode, it is easy to form the light emitting device and the cathode as one unit.

Furthermore, the light emitting device may be a schottky junction or MIS (Metal Insulator Semiconductor) structure of diamond and metal. Since the light emitted by schottky junction or MIS structure is in short wavelengths, electrons in deep levels can be excited and the electron energy after the excitation is high. Consequently the electron emission probability is high and emission of electron is facilitated.

The electron emission face of the cathode has preferably sharpened projections. Since the electric field is concentrated on the tips of the sharpened projections, the operation voltage may be lowered.

The energy of the light wave emitted from the light emitting device preferably includes 5.0-5.4 eV. This wavelength is mainly derived from the free exciton of diamond. Using this wavelength, electrons can be excited from the deep level to the conduction band, for example by exciting from the level of boron, which is the impurity of p-type, a high efficient electron emission may be obtained.

Further, it is preferable that the energy of the light wave emitted from the light emitting device is at or above 2.0 eV. The wavelength at or above 2.0 eV includes the band A which is derived from a defect of diamond or the like, and the light at or above 2.0 eV can activate the level near the conduction band. For example the impurity level of n-type nitrogen doped diamond can be excited, and an efficient emission from the n-type diamond cathode may be obtained. In conventional photocathodes, electrons in the valence band are excited by light with more energy than the band gap but based on the composition of the present invention, the excitation is possible by light with smaller energy than the band gap of diamond. Thus, it is preferable that the light from the light emitting device excites the electrons in the impurity level of diamond to the conduction band.

Still further, it is preferable that the light from the light emitting device excites the electrons in the band gap level of diamond to the conduction band. Especially, in the case of the p-type diamond cathode, it is preferable that the light from the light emitting device excites the electrons in the levels due to any one of followings: graphite; non-crystalline carbon; fullerene; lattice defect; dislocation defect and grain boundary defect, to the conduction band. Using this excitation for an electron beam source can increase the amount of the electron emission, because even the light wave with smaller energy than the band gap of diamond can excite the electrons to the conduction band.

Furthermore, it is preferable that n-type diamond includes as an impurity at least one element of nitrogen, phosphorous, sulfur or lithium, or boron together with any one of these elements. Using such an impurity increases the carrier electrons resulting in the increase of the electrons that are excited by the light emitting device, and therefore it is a preferable way for increasing the electron emission.

The light emitting device is not limited to diamond. For example, III-V family semiconductors such as nitrides semiconductors may be used. For example, GaN, AlN, cBN and the like may be used. Especially cBN has a wide band gap of 6.3 eV and a high emission energy, and its crystal structure is similar to diamond. Consequently it is suitable for making a laminated structure such as a heteroepitaxial structure.

The light emitting device and the cathode are preferably formed as one unit. By making them one unit, the distance between the electron emission face and the light emitting device can be made short, the loss of light is less, the efficiency of photoelectric conversion is enhanced, and the electron beam source, which is made of the diamond electron emission device, can be made smaller. Especially if the light emitting device is diamond, it is easier to unify the cathode and the light emitting device.

Further, the present invention provides an electron beam source made by a diamond electron emission device, wherein a light emitting device for irradiating a cathode and the cathode, of which at least the electron emission face is a diamond, are disposed together in an electron gun. By composing such a way, a small electron beam source is provided which can be operated with lower voltage.

The electron beam source of the present invention is preferably operated by applying a positive voltage to an anode against a cathode, wherein the anode is disposed with a distance from the cathode, in which at least the electron emission face is diamond.

Further, a control electrode, which controls the emission electron current of the cathode, may be disposed between the cathode and the anode. Using the control electrode, the quantity of the emitting electrons may be controlled freely.

The above, and other objects, features and advantages of the present invention will become apparent from the following description read in conjunction with the accompanying drawings, in which like reference numerals designate the same elements.

### BRIEF DESCRIPTION OF DRAWINGS

FIG. 1 is a cross section drawing of a diamond electron emission device of the present invention.

FIG. 2 is a band chart of a diamond electron emission device of FIG. 1.

FIG. 3 is a cross section drawing of the other diamond electron emission device of the present invention.

FIG. 4 is a band chart of a diamond electron emission device of FIG. 3.

FIG. 5 is a cross section drawing of the other diamond electron emission device of the present invention.

FIG. 6 is a cross section drawing of the other diamond electron emission device of the present invention.

FIG. 7 is a band chart of a diamond electron emission device of FIG. 6.

FIG. 8 is a cross section drawing of a conventional diamond electron emission device.

### BEST MODE FOR CARRYING OUT THE INVENTION

### The First Embodiment

N-type sulfur doped diamond is synthesized by the microwave plasma CVD method on a (100) face of a single crystal of a p-type diamond, which has been synthesized by the high temperature and high pressure method. The synthetic conditions are as follows: the temperature of the p-type diamond is 825 deg. Centigrade, methane/hydrogen concentration ratio is 1.0%, and hydrogen sulfide/methane concentration ratio is 1000 ppm. The n-type sulfur doped diamond is synthesized to 10 microns thick.

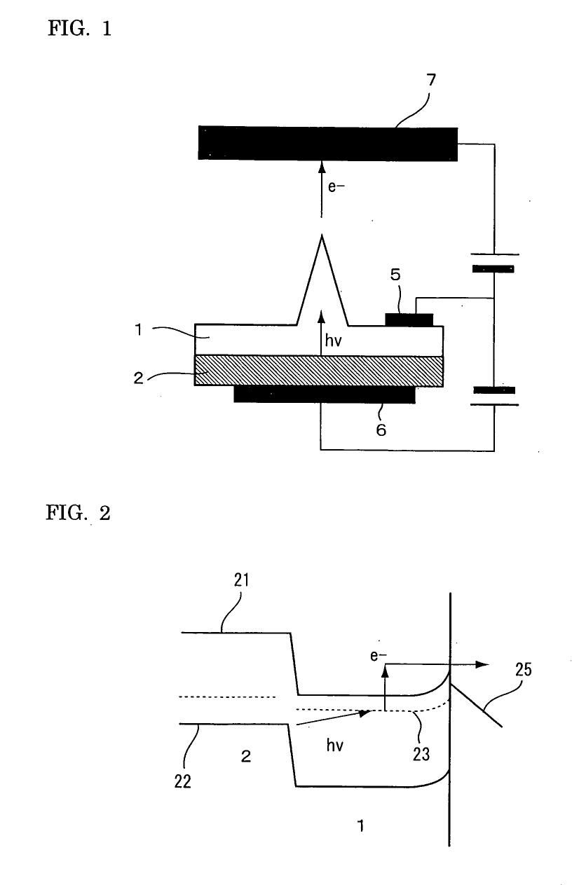

Next, a 1 micron thick Al film is formed by sputtering on the n-type sulfur doped diamond. The Al film is made into 5 micron dots by the photolithography and the wet etching methods, and then the sulfur doped diamond 1 is made into a projection form as shown in FIG. 1 by etching the sulfur doped diamond by the RIE method. After that the surface of the sulfur doped diamond is oxygen terminated by annealing at 400 deg. Centigrade for 30 min in the atmosphere.

Next, electrodes 5 and 6 are formed on the flat part of the sulfur doped diamond 1 and on the opposite side of the face where the sulfur doped diamond of p-type diamond 2 is formed. The procedure is as follows: Ar ion is injected to the diamond face on which an electrode is to be formed and diamond is changed to graphite, and then Ti/Au is evaporated while heating at 300 deg. Centigrade to form ohmic electrodes 5, 6.

The diamond with a projection part on which these electrodes are formed is placed in a vacuum chamber (not shown), and an anode 7 is disposed at a distance of 100 microns from the tip of the projection.

At first, when increasing voltage is applied between the electrode 5 and the anode 7, the emission of electrons from the projection part of the diamond is detected from 1 kV. Next, when 10 V is applied between the electrodes 5 and 6, the light emission hv from the pn junction layer is confirmed. The wavelength of this light is broad ranged but the main wavelengths are 235 nm for free exciton emission and band A emission centered at 430 nm.

Further, when increasing voltage is applied to the electrode 5 and 7 while maintaining the light emission from the pn junction layer, the electron emission is detected from 650 V. Thus it is confirmed that the voltage at which the electron emission starts is lower with light emission.

As shown in FIG. 2, the electrons occupying the impurity level 23 of n-type diamond 1 are excited with light emission hv to the conduction band 21 which is higher than the vacuum level 25, and the threshold voltage, at which electron emission starts, is lowered by a large margin. The electron emission current detected at the anode at this time is increased also.

### The Second Embodiment

N-type phosphorous doped diamond 1 is synthesized by the microwave plasma CVD method on a (111) face of a single crystal 10 of a Ib-type diamond, which has been synthesized by the high temperature and high pressure method. The synthetic conditions are as follows: the temperature of the Ib-type diamond is 870 deg. Centigrade, methane/hydrogen concentration ratio is 0.05%, and phosphine/methane concentration ratio is 10000 ppm. The n-type phosphorous doped diamond is synthesized to a thickness of 10 microns.

P-type boron doped diamond is synthesized on n-type diamond using the same micro plasma CVD method. The synthetic conditions are as follows: the temperature of the Ib-type diamond is 830 deg. Centigrade, methane/hydrogen concentration ratio is 6.0%, diborane/methane concentration ratio is 167 ppm. The p-type boron doped diamond is synthesized to 10 microns thick. There are many lattice defects such as twin crystal and the like in p-type boron doped diamond.

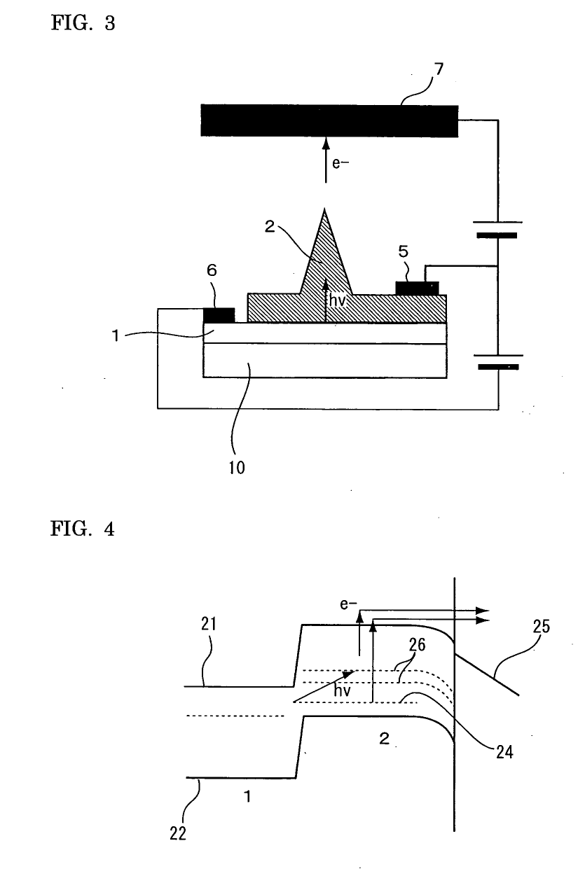

Next, dotted Al film is formed on p-type diamond in a similar way to the first embodiment, and p-type diamond 2 is etched by the RIE method and processed to a shape with a projection as shown in FIG. 3. Then the surface of the p-type diamond is hydrogen terminated by carrying out the hydrogen plasma treatment at 850 deg. Centigrade for 10 min in a CVD apparatus. Further, ohmic electrodes 5 and 6 are formed with Ti/Au as described in the first embodiment.

Next, as described in the first embodiment, the device is placed in a vacuum chamber together with an anode 7 which is separated by a distance of 100 microns. An increasing voltage is applied between the electrode 5 and the anode 7 in a similar manner as described in the first embodiment, and the electron discharge is detected from the projection part of the p-type diamond from 1.5 kV. Next, when 10 V is applied between the electrodes 5 and 6, the light emission hv from the pn junction layer is confirmed. The wavelength of this light is broad ranged but the main wavelengths are 235 nm for free exciton emission, with band A emission centered around 430 nm.

Next, when increasing voltage is applied to the electrode 5 and 7 while maintaining the light emission from the pn junction layer, the electron emission is detected from 800 V. Thus it is confirmed that the voltage at which the electron emission starts is lowered with the light emission.

As shown in FIG. 4, the electrons occupying the impurity level 24 and the level due to the lattice defect 26 of p-type diamond 2 are excited with light emission hv to the conduction band 21 which is higher than the vacuum level 25, and the threshold voltage, at which electron emission starts, is lowered by a large margin. The electron emission current detected at the anode at this time is increased also.

### The Third Embodiment

P-type boron doped diamond 1 is synthesized by the microwave plasma CVD method on a (100) face of a single crystal 10 of a Ib-type diamond, which has been synthesized by the high temperature and high pressure method. The synthetic conditions are as follows: the temperature of the Ib-type diamond is 830 deg. Centigrade, methane/hydrogen concentration ratio is 6.0%, and diborane/methane concentration ratio is 167 ppm. The p-type boron doped diamond is synthesized to 10 microns thick.

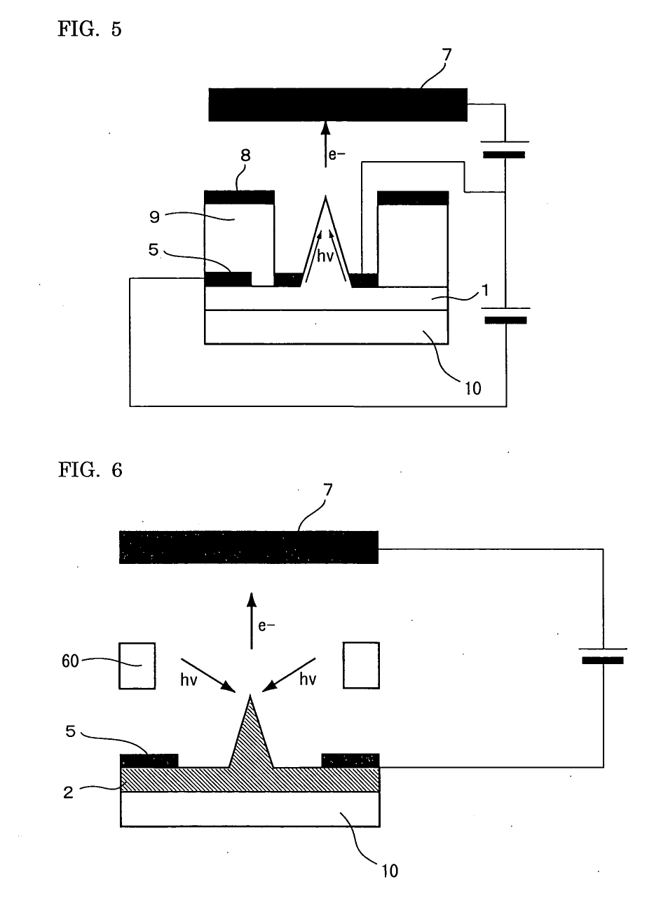

Next, dotted Al film is formed on p-type diamond 1 in a similar way to the first embodiment, and p-type diamond is etched by the RIE method and processed to a shape with a projection as shown in FIG. 5. Further, an ohmic electrode 5 is formed with Ti/Au as described in the first embodiment. Still further, a schottky electrode 4 is formed by evaporating W around the projection part. Furthermore a control electrode 8 is formed at the outer periphery of the boron doped diamond by evaporating an insulator 9 consisting of SiO₂ and Mo.

Next, as described in the first embodiment, the device is placed in a vacuum chamber together with an anode 7 which is separated by a distance of 100 microns. As described in the first embodiment, when increasing voltage is applied between the electrode 5 and the anode 7, and between the electrode 5 and 8, the electron discharges are detected from the projection part of the p-type diamond at 1 kV and 300 V, respectively. Next, the light emission from the schottky junction layer is detected by applying 10 V between the electrode 5 and 4. The wavelength of the light emission covers a wide range that includes the free exciton emission and the band A emission.

Next, when increasing voltage is applied to the electrode 5 and 7 while maintaining the light emission from the pn junction layer, electron emission is detected from 600 V. Thus, with the light emission, the electrons occupying the impurity level of the p-type diamond are excited to the conduction band which is higher than the vacuum level, and the threshold voltage, at which electron emission starts, is lowered by a large margin. The electron emission current detected at the anode at this time is increased also.

Further, the electron emission current changes in linear proportion when the voltage between the electrodes 5 and 8 is changed. Still further the electron emission current changes proportionally with the light emission, which is changed by changing the voltage between the electrodes 5 and 4.

### The Fourth Embodiment

As described in the third embodiment, p-type boron doped diamond 2 is synthesized on a (100) face of a single crystal 10 of a Ib-type diamond to a thickness of 10 microns, and the p-type diamond is processed to a shape with a projection as shown in FIG. 6. After the surface of the p-type diamond is hydrogen terminated as described in the second embodiment, the ohmic electrode 5 is formed by Ti/Au.

A diamond LED, which utilizes a pn junction of the boron doped diamond and the phosphorous doped diamond, is separately prepared. The device is placed in a vacuum chamber together with this diamond LED 60 and the anode 7. The diamond LED is disposed on the periphery of the projection part of the p-type diamond, and the anode is disposed at a distance of 100 microns from the tip of the projection part.

As described in the first embodiment, when increasing voltage is applied between the electrode 5 and the anode 7, the electron emission from the projection part of the p-type diamond is detected from 1 kV. Next, 30 V is applied to the diamond LED, and light emission is induced. This light emission includes multiple emissions and the major one is the free exciton emission and as a sub band, the band A emission. When increasing voltage is applied between the electrode 5 and the anode 6 while maintaining the LED light emission, the electron discharge is detected from 650 V, confirming the lowering of the threshold voltage with the onset of the electron emission.

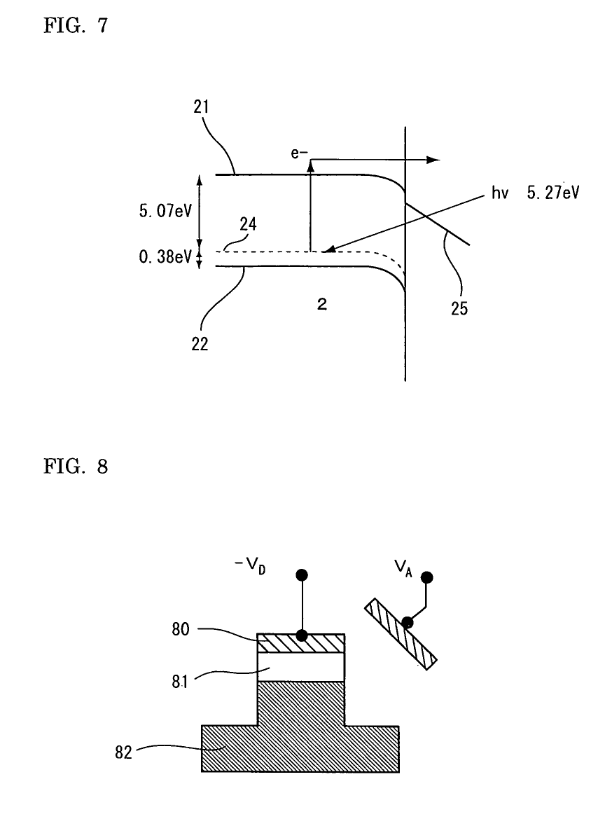

FIG. 7 shows the band chart of diamond. The figure shows a conduction band 21 and a valence band 22. The electrons occupying the impurity level of the p-type diamond are excited by the 5.27 eV free exciton light emission to the conduction band which is higher than the vacuum level, and the hydrogen terminated surface shows a negative electron affinity. Therefore the electrons are easily emitted from this device. The electron emission current changes with linear proportion with the change in the light emission of the LED.

### The Fifth Embodiment

After a silicon wafer is scratched using diamond powder, p-type boron doped diamond is synthesized using the filament CVD method. The conditions for the synthesis are as follows: the temperature of the silicon wafer is 800 deg. Centigrade, the filament temperature is 2,100 deg. Centigrade, the pressure is 13.3 kPa, methane/hydrogen concentration ratio is 2.0%, and trimethyl borate dissolved in acetone is treated with argon gas bubbling so that the boron/hydrogen concentration ratio is 0.1%. The p-type boron doped diamond is synthesized to 20 microns thickness. This p-type diamond demonstrates p-type electrical conduction and also contains defects such as crystal grain boundary, dislocation and the like because it is polycrystal.

Next, after polishing the surface of this p-type boron doped diamond, the dotted Al film is formed as described in the first embodiment. The Al film is etched by the RIE method, and the p-type boron doped diamond is processed to a projection shape. This is again placed in the filament CVD apparatus, and treated with the hydrogen plasma at 850 deg. Centigrade for 10 min to hydrogen terminate the surface of p-type diamond. Further as described in the first embodiment ohmic electrodes are formed by Ti/Au.

As shown in FIG. 6, as described in the fourth embodiment, a diamond LED which utilizes pn junction is prepared separately, and this diamond LED 60, the anode 7 and the p-type diamond with the projection shape 2 are placed in a vacuum chamber. The diamond LED is disposed on the periphery of the projection part of the p-type diamond, and the anode is disposed at 100 microns from the tip of the projection part.

As described in the first embodiment, when an increasing voltage is applied between the electrode 5 and the anode 7, the electron emission from the projection part of the p-type diamond is detected from 1.5 kV. Next, 30 V is applied to the diamond LED, and the light emission is induced. This light emission includes multiple emissions and the major one is the free exciton emission and as a sub band, the band A emission. When increasing voltage is applied between the electrode 5 and the anode 6 while maintaining the LED light emission, the electron discharge is detected from 600 V, confirming the lowering of the threshold voltage with the onset of the electron emission.

### The Sixth Embodiment

After a silicon wafer is scratched using diamond powder, p-type boron doped diamond is synthesized using the filament CVD method. The conditions for the synthesis are as follows: the temperature of the silicon wafer is 800 deg. Centigrade, the filament temperature is 2,100 deg. Centigrade, the pressure is 13.3 kPa, methane/hydrogen concentration ratio is 2.0%, and trimethyl borate dissolved in acetone is treated with argon gas bubbling so that the boron/hydrogen concentration ratio is 0.1%. The p-type boron doped diamond is synthesized to 20 microns thick. This p-type diamond demonstrates p-type electrical conduction and also contains defects such as crystal grain boundary, dislocation and the like because it is polycrystal.

Next, after polishing the surface of this p-type boron doped diamond, the dotted Al film is formed as described in the first embodiment. The Al film is etched by the RIE method, and the p-type boron doped diamond is processed to a projection shape. This is again placed in the filament CVD apparatus, and treated with the hydrogen plasma at 850 deg. Centigrade for 10 min to hydrogen terminate the surface of p-type diamond. Further as described in the first embodiment ohmic electrodes are formed by Ti/Au.

As shown in FIG. 6, a LED which utilizes pn junction of aluminum nitride is prepared separately, and this LED 60, the anode 7 and together with the p-type diamond with the projection shape 2 are placed in a vacuum chamber. The diamond LED is disposed on the periphery of the projection part of the p-type diamond, and the anode is disposed 100 microns from the tip of the projection part.

As described in the first embodiment, when an increasing voltage is applied between the electrode 5 and the anode 7, the electron emission from the projection part of the p-type diamond is detected from 1.5 kV. When increasing voltage is applied between the electrode 5 and the anode 6 while maintaining the LED light emission, the electron discharge is detected from 500 V, confirming the lowering of the threshold voltage with the onset of the electron emission.

### INDUSTRIAL APPLICABILITY

Because the diamond electron emission device of the present invention consists of a light emitting device to excite the electrons, a small electron emission device, which has superior electron emission characteristics with low operational voltage, may be obtained. Because the light emitting device and the diamond cathode are disposed in an electron gun, an electron beam source may be obtained which is small and has very efficient electron emission characteristics. Thus, using the electron emission device of the present invention, the present invention can provide more efficient electron-beam application apparatuses, such as microwave oscillators, high frequency amplification devices, electron beam lithography apparatuses or the like, than the conventional ones.

1. A diamond electron emission device comprising a light emitting device for irradiating light to a cathode, wherein at least an electron emission face of said cathode is made of diamond.

2. A diamond electron emission device according to claim 1, wherein said light emitting device is made of diamond.

3. A diamond emission device according to claim 1 or 2, wherein said electron emission face of said cathode is an n-type diamond semiconductor.

4. A diamond emission device according to claim 1, wherein said electron emission face of said cathode is a p-type diamond semiconductor.

5. A diamond electron emission device according to claim 4, wherein said p-type diamond semiconductor includes crystal defects or an sp2 component.

6. A diamond electron emission device according to claim 1, wherein said electron emission face of said cathode is hydrogen terminated.

7. A diamond electron emission device according to claim 1, wherein said electron emission face of said cathode is oxygen terminated.

8. A diamond electron emission device according to claim 1, wherein said light emitting device is composed of a pn junction of diamond, a schottky junction or a MIS structure.

9. A diamond electron emission device according to claim 1, wherein said electron emission face of said cathode contains a sharpened projection part.

10. A diamond electron emission device according to claim 1, wherein wavelength energy of light emitted from said light emitting device includes 5.0-5.4 eV.

11. A diamond electron emission device according to claim 1, wherein wavelength energy of light emitted from said light emitting device is equal to or greater than 2.0 eV.

12. A diamond electron emission device according to claim 1, wherein light from said light emitting device excites electrons in an impurity level to a conduction band.

13. A diamond electron emission device according to claim 1, wherein light from said light emitting device excites electrons in a band gap level to a conduction band.

14. A diamond electron emission device according to claim 1, wherein light from said light emitting device excites electrons in a level resulting from any of following components of p-type diamond: graphite; non-crystalline carbon; diamond-like carbon; fullerene; lattice defect; dislocation defect or grain boundary defect, to a conductive band.

15. A diamond electron emission device according to claim 3, wherein said n-type diamond contains as an impurity at least one element among nitrogen, phosphorous, sulfur and lithium, or any one of said elements and boron.

16. A diamond electron emission device according to claim 1, wherein said light emitting device is composed as one unit with said cathode.

17. An electron beam source utilizing a diamond electron emission device, wherein a light emitting device for irradiating a cathode and a cathode, in which at least an electron emission face is diamond, are disposed together in an electron gun.

18. An electron beam source utilizing a diamond electron emission device according to claim 17, wherein:
an anode is separated by a space from said cathode, in which at least an electron emission face is diamond; and
a voltage that is positive relative to said cathode is applied to said anode.

19. An electron beam source utilizing a diamond electron emission device according to claim 18, wherein a control electrode is disposed between said cathode and said anode to regulate an emission electron current from said cathode.
